(19) United States
(12) Patent Application Publication
(10) Pub. No.: US 2026/0075480 A1
(43) Pub. Date: Mar. 12, 2026

(54) MULTI-CRITERIA HANDOVER IN SDN-BASED MULTI-RAT NETWORKS

(71) Applicant: University of Florida Research Foundation, Incorporated, Gainesville, FL (US)

(72) Inventors: Janise McNair, Gainesville, FL (US); Pavan Kumar Mangipudi, Gainesville, FL (US); Sharon Boamah, Gainesville, FL (US)

(21) Appl. No.: 19/310,397

(22) Filed: Aug. 26, 2025

Related U.S. Application Data
(60) Provisional application No. 63/692,757, filed on Sep. 10, 2024.

(51) Int. Cl. H04W 36/00; H04W 36/14; H04W 36/30

(52) U.S. Cl. CPC H04W 36/00835; H04W 36/0094; H04W 36/144; H04W 36/304

(57) ABSTRACT

A method comprising generating a decision matrix comprising a plurality of candidate network connection nodes and network quality measurements; determining a plurality of criterion weights based on a plurality of entropy values corresponding to a plurality of criteria; generating, using the plurality of network quality measurements, a plurality of rankings for the plurality of candidate network connection nodes based on the plurality of criteria and the plurality of criterion weights; assigning, based on the plurality of rankings for the plurality of candidate network connection nodes, a highest-ranking candidate network connection node as a target node and a second-ranking candidate network connection node as a stand-in node; assigning the stand-in node as the target node if the target node comprises a base station and the RSSI value of the stand-in node is greater than the RSSI value of the target node; and initiating a handover to the target node.

### CROSS REFERENCE TO RELATED APPLICATION

This application claims the priority of U.S. Provisional Application No. 63/692,757, entitled “MULTI-CRITERIA HANDOVER IN SDN-BASED MULTI-RAT NETWORKS,” filed on Sep. 10, 2024, the disclosure of which is hereby incorporated by reference in its entirety.

### GOVERNMENT SUPPORT

This invention was made with government support under 2030122 awarded by the National Science Foundation. The government has certain rights in the invention.

### TECHNICAL FIELD

Various embodiments of the present disclosure relate to mobile cellular telecommunication networks, and more particularly to optimizing handover decisions in heterogeneous, multiple radio access technologies networks.

### BACKGROUND

Next generation cellular networks, such as Beyond 5G (B5G), may provide enhanced spectral efficiency, energy efficiency, native AI integration, and continued latency and speed improvements over previous generations. For example, B5G may be tasked with extending connectivity between and among humans, between and among machines, and a combination of both, with respect to applications in a variety of fields, such as industrial, agricultural, Internet-of-Things (IoT), autonomous vehicles, drones, or satellites. Diverse deployment scenarios with macro cells, small cells, indoor coverage solutions, and/or private networks, among other techniques, may enable network providers to extend network coverage and improve connectivity. As such, networks, such as B5G, may comprise dense, heterogeneous wireless networks that coexist within a wide range of radio access technologies (RATs).

The co-existence of heterogeneous, multiple RATs (Multi-RATs) may provide an ecosystem that may be leveraged to address connectivity challenges of networks, such B5G. However, conventional handover decision mechanisms are not able to capture the characteristic, parametric, and/or performance differences associated with each co-existing RAT in a multi-RAT network. Furthermore, a single base station may not provide sufficient management processes for organizing cross-RAT handover decisions. Convention techniques for optimizing multi-RAT handovers are based on received signal strength indicator (RSSI) but neglect important merits and/or characteristics of surrounding networks, as well as parametric and/or performance differences among RATs. That is, each RAT may comprise different propagation effects and channel constraints. Thus, a handover mechanism that uses only RSSI may provide inferior handover performance.

### BRIEF SUMMARY

Various embodiments described herein relate to a multiple criteria decision-making (MCDM)-based method for handover in software-defined networking (SDN)-based dense multi-radio access technology (RAT) networks.

According to some embodiments, a computer-implemented method comprises generating, by one or more processors, a decision matrix, wherein (i) the decision matrix comprises a plurality of candidate network connection nodes and a plurality of network quality measurements corresponding to the plurality of candidate network connection nodes, (ii) the plurality of network quality measurements comprises received signal strength indicator (RSSI) and link delay, and (iii) the plurality of candidate network connection nodes correspond to a plurality of wireless access points or base stations that are within a range of a user equipment (UE); determining, by the one or more processors, a plurality of criterion weights based on a plurality of entropy values corresponding to a plurality of criteria; generating, by the one or more processors and using the plurality of network quality measurements, a plurality of rankings for the plurality of candidate network connection nodes based on the plurality of criteria and the plurality of criterion weights; assigning, by the one or more processors and based on the plurality of rankings for the plurality of candidate network connection nodes, a highest-ranking candidate network connection node from the plurality of candidate network connection nodes as a target node and a second-ranking candidate network connection node from the plurality of candidate network connection nodes as a stand-in node; responsive to determining (i) the target node comprises a base station and (ii) a stand-in node RSSI value of the stand-in node is greater than (a) a target node RSSI value of the target node and (b) a threshold value, assigning, by the one or more processors, the stand-in node as the target node; and initiating, by the one or more processors, a radio link transfer or handover of the UE to the target NODE.

In some embodiments, the computer-implemented method further comprises normalizing the plurality of network quality measurements by converting a plurality of raw values from the plurality of network quality measurements into a plurality of normalized values that are within a scale or range. In some embodiments, the plurality of criteria is based on RSSI, link delay, bandwidth, or base station load. In some embodiments, the plurality of criteria is network, coverage, user, or service-based. In some embodiments, generating the plurality of rankings comprises ranking the plurality of candidate network connection nodes by (i) determining an ideal possible candidate network connection node and an anti-ideal possible candidate network connection node and (ii) determining, based on the plurality of criteria and the plurality of criterion weights, a distance or similarity measure of the plurality of candidate network connection nodes relative to the ideal possible candidate network connection node or the anti-ideal possible candidate network connection node. In some embodiments, the highest-ranking candidate network connection node comprises a shortest Euclidean distance from an ideal possible candidate network connection node or a longest Euclidean distance from the anti-ideal possible candidate network connection node.

According to some embodiments, a system comprises one or more processors and at least one memory storing processor-executable instructions that, when executed by any of the one or more processors, causes the one or more processors to perform operations comprising: generating a decision matrix, wherein (i) the decision matrix comprises a plurality of candidate network connection nodes and a plurality of network quality measurements corresponding to the plurality of candidate network connection nodes, (ii) the plurality of network quality measurements comprises received signal strength indicator (RSSI) and link delay, and (iii) the plurality of candidate network connection nodes correspond to a plurality of wireless access points or base stations that are within a range of a user equipment (UE); determining a plurality of criterion weights based on a plurality of entropy values corresponding to a plurality of criteria; generating, using the plurality of network quality measurements, a plurality of rankings for the plurality of candidate network connection nodes based on the plurality of criteria and the plurality of criterion weights; assigning, based on the plurality of rankings for the plurality of candidate network connection nodes, a highest-ranking candidate network connection node from the plurality of candidate network connection nodes as a target node and a second-ranking candidate network connection node from the plurality of candidate network connection nodes as a stand-in node; responsive to determining (i) the target node comprises a base station and (ii) a stand-in node RSSI value of the stand-in node is greater than (a) a target node RSSI value of the target node and (b) a threshold value, assigning the stand-in node as the target node; and initiating a radio link transfer or handover of the UE to the target node.

In some embodiments, the operations further comprise normalizing the plurality of network quality measurements by converting a plurality of raw values from the plurality of network quality measurements into a plurality of normalized values that are within a scale or range. In some embodiments, the plurality of criteria is based on RSSI, link delay, bandwidth, or base station load. In some embodiments, the plurality of criteria is network, coverage, user, or service-based. In some embodiments, generating the plurality of rankings comprises ranking the plurality of candidate network connection nodes by (i) determining an ideal possible candidate network connection node and an anti-ideal possible candidate network connection node and (ii) determining, based on the plurality of criteria and the plurality of criterion weights, a distance or similarity measure of the plurality of candidate network connection nodes relative to the ideal possible candidate network connection node or the anti-ideal possible candidate network connection node. In some embodiments, the highest-ranking candidate network connection node comprises a shortest Euclidean distance from an ideal possible candidate network connection node or a longest Euclidean distance from the anti-ideal possible candidate network connection node.

According to some embodiments, one or more non-transitory computer-readable storage media storing instructions that, when executed by one or more processors, cause the one or more processors to perform operations comprising generating a decision matrix, wherein (i) the decision matrix comprises a plurality of candidate network connection nodes and a plurality of network quality measurements corresponding to the plurality of candidate network connection nodes, (ii) the plurality of network quality measurements comprises received signal strength indicator (RSSI) and link delay, and (iii) the plurality of candidate network connection nodes correspond to a plurality of wireless access points or base stations that are within a range of a user equipment (UE); determining a plurality of criterion weights based on a plurality of entropy values corresponding to a plurality of criteria; generating, using the plurality of network quality measurements, a plurality of rankings for the plurality of candidate network connection nodes based on the plurality of criteria and the plurality of criterion weights; assigning, based on the plurality of rankings for the plurality of candidate network connection nodes, a highest-ranking candidate network connection node from the plurality of candidate network connection nodes as a target node and a second-ranking candidate network connection node from the plurality of candidate network connection nodes as a stand-in node; responsive to determining (i) the target node comprises a base station and (ii) a stand-in node RSSI value of the stand-in node is greater than (a) a target node RSSI value of the target node and (b) a threshold value, assigning the stand-in node as the target node; and initiating a radio link transfer or handover of the UE to the target node.

In some embodiments, the operations further comprise normalizing the plurality of network quality measurements by converting a plurality of raw values from the plurality of network quality measurements into a plurality of normalized values that are within a scale or range. In some embodiments, the plurality of criteria is based on RSSI, link delay, bandwidth, or base station load. In some embodiments, the plurality of criteria is network, coverage, user, or service-based. In some embodiments, generating the plurality of rankings comprises ranking the plurality of candidate network connection nodes by (i) determining an ideal possible candidate network connection node and an anti-ideal possible candidate network connection node and (ii) determining, based on the plurality of criteria and the plurality of criterion weights, a distance or similarity measure of the plurality of candidate network connection nodes relative to the ideal possible candidate network connection node or the anti-ideal possible candidate network connection node. In some embodiments, the highest-ranking candidate network connection node comprises a shortest Euclidean distance from an ideal possible candidate network connection node or a longest Euclidean distance from the anti-ideal possible candidate network connection node.

### BRIEF DESCRIPTION OF THE DRAWINGS

Embodiments incorporating teachings of the present disclosure are shown and described with respect to the figures presented herein.

FIG. 1 is a diagram of an example SDN-based multi-RAT network architecture in accordance with some embodiments of the present disclosure.

FIG. 2 is a diagram of an example SDNC in accordance with some embodiments of the present disclosure.

FIG. 3 is a diagram of an example user equipment in accordance with some embodiments of the present disclosure.

FIG. 4 is a flowchart of process for performing a handover of a user equipment in accordance with some embodiments discussed herein.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### General Overview and Example Technical Improvements

The present disclosure provides systems and methods for providing multiple criteria decision-making (MCDM) handover in software-defined networking (SDN)-based dense multiple radio access technologies (multi-RAT) networks. As described above, a handover mechanism that is based solely on received signal strength indicator (RSSI) and does not consider performance characteristics for quality of service and quality of experience, may fall short of capturing the essence of each RAT within a multi-RAT network, resulting in inferior handover performance.

According to various embodiments of the present disclosure, an MCDM handover technique facilitates the offloading of user equipment (UE) onto WiFi nodes while improving throughput and reducing failed handovers. The disclosed MCDM handover technique may consider RSSI and delay to provide UEs with better latency associated with connection delay. The disclosed MCDM handover technique may comprise determining entropy-based weights for each decision criterion to determine the relative importance of one or more criteria. Moreover, the disclosed MCDM handover technique may rank candidate network connection nodes using “technique for order of preference by similarity to the ideal solution” (TOPSIS), which may comprise determining a similarity of each alternative candidate network connection node to an ideal possible alternative candidate network connection node and an anti-ideal possible alternative candidate network connection node, which facilitates ranking of the alternative candidate network connection nodes accordingly. Accordingly, the disclosed MCDM handover method may provide improved performance over conventional RSSI-based selection by reducing handover failure ratio, providing decreased delay difference, and improving throughput.

### Example Technical Implementation of Various Embodiments

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM),Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described with reference to example operations, steps, processes, blocks, and/or the like. Thus, it should be understood that each operation, step, process, block, and/or the like may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### Example Network Architecture

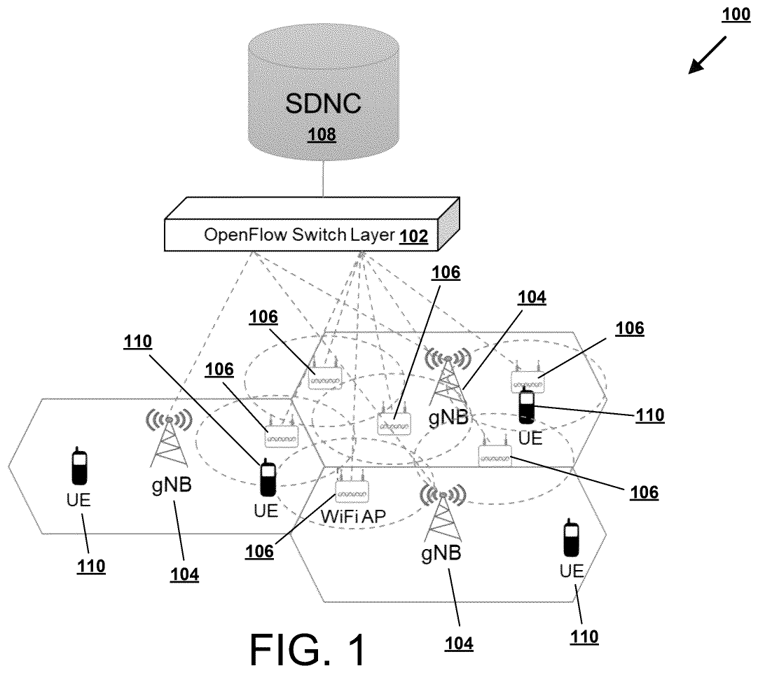

FIG. 1 is a diagram of an example SDN-based multi-RAT network architecture 100 in accordance with some embodiments of the present disclosure. The architecture 100 comprises an OpenFlow switch layer 102 that comprises one or more OpenFlow-enabled switches that are communicatively coupled to a plurality of 5G base stations, referred to as “next generation Node B” (gNBs) 104, and a plurality of WiFi access points (APs) 106. The architecture 100 further comprises a centralized SDN controller (SDNC) 108 that connects the gNBs 104 with the WiFi APs 106 at the MAC and IP layers. The gNBs and the WiFi APs may forward packets to/from the SDNC 108 via the OpenFlow switch layer 102. The OpenFlow-enabled switches in the OpenFlow switch layer 102 may be configured to forward packets between the gNBs 104 and/or the WiFi APs 106 and the SDNC 108.

The SDNC 108 may be configured to monitor and route traffic through the OpenFlow-enabled switches in the OpenFlow switch layer 102. With a global view of the overall network comprising the gNBs 104 and the WiFi APs 106, the SDNC 108 may comprise information about the positions and corresponding addresses of every node in the network. Ingress packets received at the OpenFlow-enabled switches in the OpenFlow switch layer 102 may be routed to destinations based on flow rules (e.g., matching with flow tables) at each OpenFlow-enabled switch. Flow rules may be installed at the OpenFlow-enabled switches in the OpenFlow switch layer 102 by the SDNC 108 by assigning one or more of MAC addresses, IP addresses, or port addresses to each ingress packet. For each ingress packet, a source and destination address may be retrieved from flow rules at the OpenFlow-enabled switches in the OpenFlow switch layer 102. In the case where there is no flow rule for an ingress packet, the ingress packet may be forwarded to the SDNC 108 to record its destination and provide the destination as a flow rule that may be provided to the OpenFlow-enabled switches in the OpenFlow switch layer 102 such that a next instance of the ingress packet may be automatically routed by the OpenFlow-enabled switches via a flow rule.

The architecture 100 further comprises a plurality of UEs 110 that are capable of using both WiFi and 5G radio access technologies (RATs). Connections between the plurality of UEs 110 and the gNBs 104 may be established based on 5G standards, through various protocols layers, such as the physical (PHY), medium access control (MAC), radio link control (RLC), packet data convergence protocol (PDCP), or radio resource control (RRC) layers. The aforementioned sets of protocols may differ for control plane and user plane as there may be different functionalities associated with each plane. Packets reaching the gNBs 104 from the UEs 110 may be processed according to various protocols, before sending the packets to a core network. However, to enable the interconnection between 5G and WiFi nodes through the SDNC 108, the MAC and IP layers at the gNBs 104 may be translated to a format that is readable by the OpenFlow-enabled switches in the OpenFlow switch layer 102 thereby interfacing the gNBs 104 with the OpenFlow enabled switches. After interfacing, MAC and IP packets may be forwarded to the OpenFlow enabled switches to enforce flow rules.

In a similar manner, a WiFi AP 106 may also be connected to a corresponding OpenFlow-enabled switch in the OpenFlow switch layer 102. L1 (e.g., PHY layer) and L2 (e.g., MAC, RLC, and/or PDCP layers) protocol translation between the WiFi AP 106 and the OpenFlow-enabled switches may enable frames originating from the WiFi AP 106 to be sent to the SDNC 108 or routed to other OpenFlow-enabled switches according to flow rules installed at the OpenFlow-enabled switches. Accordingly, packets originating from different RATs may be translated with respect to each RAT's L1 and L2 protocols and routed through the OpenFlow-enabled switches in the OpenFlow switch layer 102 to their destinations.

The RSSI of each UE 110 may be measured and compared with the WiFi APs 106 in their respective coverage area. An average link delay may be determined periodically to facilitate an MCDM-based handover. Handover optimization and mobility management applications may execute on the SDNC 108 to provide an interconnection between RATs at the Internet protocol (IP) level and to optimize packet forwarding.

### Example Software-Defined Networking Controller

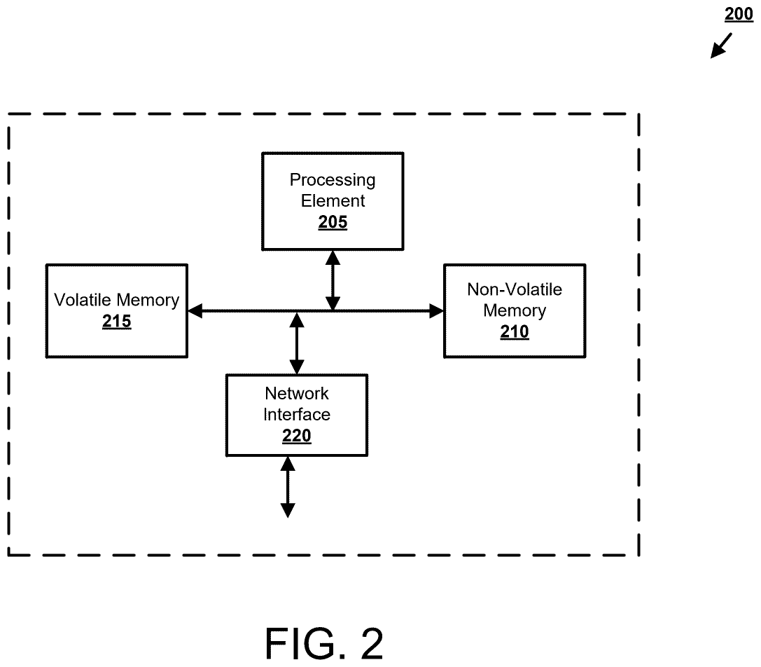

FIG. 2 is a diagram of an example SDNC 200 in accordance with some embodiments of the present disclosure. In general, the terms computing entity, computer, entity, device, system, and/or similar words used herein interchangeably may refer to, for example, one or more computers, computing entities, distributed systems, servers or server networks, blades, gateways, switches, processing devices, processing entities, relays, routers, network access points, base stations, the like, and/or any combination of devices or entities adapted to perform the functions, operations, and/or processes described herein. Such functions, operations, and/or processes may include, for example, transmitting, receiving, operating on, processing, storing, determining, creating/generating, monitoring, evaluating, comparing, and/or similar terms used herein interchangeably. In one embodiment, these functions, operations, and/or processes may be performed on data, content, information, and/or similar terms used herein interchangeably.

As indicated, in one embodiment, the SDNC 200 may also include one or more network interfaces 220 for communicating with various computing entities, such as by communicating data, content, information, and/or similar terms used herein interchangeably that may be transmitted, received, operated on, processed, displayed, stored, and/or the like.

As shown in FIG. 2, in one embodiment, the SDNC 200 may include, or be in communication with, one or more processing elements 205 (also referred to as processors, processing circuitry, and/or similar terms used herein interchangeably) that communicate with other elements within the SDNC 200 via a bus, for example. As will be understood, the processing elements 205 may be embodied in a number of different ways.

For example, the processing elements 205 may be embodied as one or more complex programmable logic devices (CPLDs), microprocessors, multi-core processors, coprocessing entities, application-specific instruction-set processors (ASIPs), microcontrollers, and/or controllers. Further, the processing elements 205 may be embodied as one or more other processing devices or circuitry. The term circuitry may refer to an entirely hardware embodiment or a combination of hardware and computer program products. Thus, the processing elements 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing elements 205 may be configured for a particular use or configured to execute instructions stored in volatile or non-volatile media or otherwise accessible to the processing elements 205. As such, whether configured by hardware or computer program products, or by a combination thereof, the processing elements 205 may be capable of performing steps or operations according to embodiments of the present disclosure when configured accordingly.

In one embodiment, the SDNC 200 may further include, or be in communication with, non-volatile media (also referred to as non-volatile storage, memory, memory storage, memory circuitry, and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the SDNC 200 may further include, or be in communication with, volatile media (also referred to as volatile storage, memory, memory storage, memory circuitry, and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing elements 205. Thus, the databases, database instances, database management systems, data, applications, programs, program modules, scripts, source code, object code, byte code, compiled code, interpreted code, machine code, executable instructions, and/or the like may be used to control certain aspects of the operation of the SDNC 200 with the assistance of the processing elements 205 and operating system.

As indicated, in one embodiment, the SDNC 200 may also include one or more network interfaces 220 for communicating with various computing entities, such as by communicating data, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the SDNC 200 may be configured to communicate via wireless external communication networks using any of a variety of protocols, such as new radio (NR), general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the SDNC 200 may include, or be in communication with, one or more input elements, such as a keyboard input, a mouse input, a touch screen/display input, motion input, movement input, audio input, pointing device input, joystick input, keypad input, and/or the like. The SDNC 200 may also include, or be in communication with, one or more output elements (not shown), such as audio output, video output, screen/display output, motion output, movement output, and/or the like.

### Example User Equipment

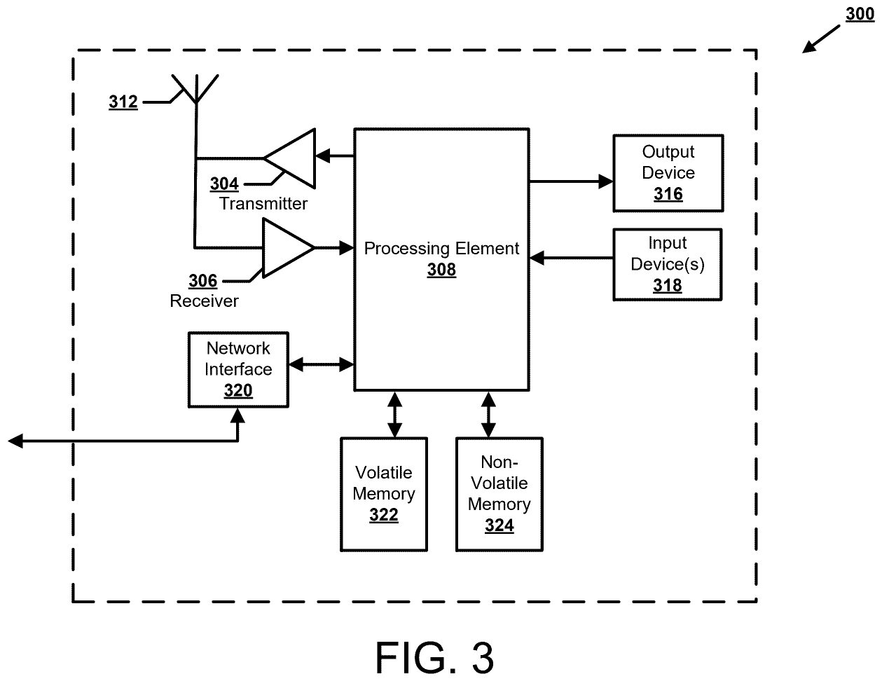

FIG. 3 is a diagram of an example user equipment 300 in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, the like, and/or any combination of devices or entities adapted to perform the functions, operations, and/or processes described herein. User equipment 300 may be operated by various parties. As shown in FIG. 3, the user equipment 300 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the user equipment 300 may be capable of operating with one or more air interface standards, communication protocols, modulation types, and access types. More particularly, the user equipment 300 may operate in accordance with any of a number of wireless communication standards and protocols, such as those described above with regard to the SDNC 200. In a particular embodiment, the user equipment 300 may operate in accordance with multiple wireless communication standards and protocols, such as NR, GPRS, UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the user equipment 300 may operate in accordance with multiple wired communication standards and protocols, such as those described above with regard to the SDNC 200 via a network interface 320.

Via these communication standards and protocols, the user equipment 300 may communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The user equipment 300 may also download changes, add-ons, and updates, for instance, to its firmware, software (e.g., including executable instructions, applications, program modules), and operating system.

According to one embodiment, the user equipment 300 may include location determining aspects, devices, modules, functionalities, and/or similar words used herein interchangeably. For example, the user equipment 300 may include outdoor positioning aspects, such as a location module adapted to acquire, for example, latitude, longitude, altitude, geocode, course, direction, heading, speed, universal time (UTC), date, and/or various other information/data. In one embodiment, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the client computing entity's 102 position in connection with a variety of other systems, including cellular towers, Wi-Fi access points, and/or the like. Similarly, the user equipment 300 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The user equipment 300 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the user equipment 300 to interact with and/or cause display of information/data from the SDNC 200, as described herein. The user input interface may comprise any of a plurality of input devices 318 (or interfaces) allowing the user equipment 300 to receive code and/or data, such as a keypad (hard or soft), a touch display, voice/speech or motion interfaces, or other input device. In some embodiments including a keypad, the keypad may include (or cause display of) the conventional numeric (0-9) and related keys ( #, *), and other keys used for operating the user equipment 300 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The user equipment 300 may also include volatile storage or memory 322 and/or non-volatile storage or memory 324, which may be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory may store databases, database instances, database management systems, data, applications, programs, program modules, scripts, source code, object code, byte code, compiled code, interpreted code, machine code, executable instructions, and/or the like to implement the functions of the user equipment 300. As indicated, this may include a user application that is resident on the user equipment 300 or accessible through a browser or other user interface for communicating with the SDNC 200 and/or various other computing entities.

In another embodiment, the user equipment 300 may include one or more components or functionality that are the same or similar to those of the SDNC 200, as described in greater detail above. As will be recognized, these architectures and descriptions are provided for exemplary purposes only and are not limited to the various embodiments.

In various embodiments, the user equipment 300 may be embodied as an artificial intelligence (AI) computing entity. Accordingly, the user equipment 300 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### Example System Operations

Various embodiments of the present disclosure describe steps, operations, processes, methods, functions, and/or the like for managing device connectivity within cellular telecommunications networks.

The Beyond 5G (B5G) generation of cellular networks may provide increased connectivity and coverage requirements over previous generations of cellular networks, such as conventional 5G which relies on increased densification of a radio access network (RAN) and deployments alone to increase connectivity. A B5G network may use other co-existing networks along with RAN densification to increase connectivity and coverage. For example, RATs, such as WiFi, Internet-of-Things (IoT) networks, autonomous vehicles, drones, and satellites may co-exist within a same umbrella of wireless networks, referred to as multi-RAT networks. Multi-RAT networks may serve as alternate network cells for transferring users from cellular networks to increase cellular spectrum availability and improve capacity. A plurality of RATs may be integrated to seamlessly move traffic between each other, optimize coverage, improve capacity, alleviate network congestion, and optimize network resources. However, multi-RAT networks come with challenges related to implementation and handover optimization.

In some embodiments, a handover may describe a process of migrating a connection of a UE (e.g., mobile user device) from one network connection node (e.g., a gNB 104 or WiFi AP 106) to another network connection node (e.g., when travelling across network cells or when a stronger signal connection to a network cell is detected). As such, migration of UEs between various RATs in a multi-RAT network may be enabled by handovers. However, frequent and unnecessary handovers may significantly reduce a quality of service perceived by a UE undergoing the handovers. Accordingly, handovers may be optimized such that mobile user devices may experience seamless and consistent network connection or service.

Conventional optimization of multi-RAT handovers may rely solely on RSSI and do not consider the characteristics of constituent heterogenous networks, as well as parametric and performance differences. For example, each RAT may have different propagation effects and channel constraints. As such, performing handovers in a multi-RAT network based on only RSSI may lead to inferior handover performance.

According to various embodiments of the present disclosure, multi-RAT handover may be performed to limit the costly usage of 5G cellular resources when possible, and to reduce the incidence of failed handovers. In particular, UEs may be offloaded to a wireless AP (e.g., WiFi APs 106 or a satellite gateway) such that cellular spectrum may be freed up for allocation to other UEs that may have critical needs. In some embodiments, a method for performing multi-RAT handover comprises (i) determining a multi-criteria decision, (ii) initiating performance of a RSSI and delay-based handover, and (iii) initiating performance of WiFi offloading using next best selection.

In some embodiments, determining a multi-criteria decision comprises (i) obtaining one or more criterion weights and (ii) ranking a plurality of candidate network connection nodes. Obtaining the one or more criterion weights may comprise calculating one or more entropy values for one or more decision criteria. In some embodiments, an entropy value may be representative of an amount of information preserved within, or a variation in, a range of values for a criterion. For example, a smaller entropy value may be associated with a larger range of information and variation in a criterion, corresponding to a larger relative weight for the criterion. Conversely, a larger entropy value may be associated with a smaller amount of information, or a smaller range of values within a criterion, corresponding to a smaller relative weight for the criterion. A relative information present in each criterion may be compared and a proportional weight may be assigned to each criterion based on the comparison.

Once criterion weights are obtained, a plurality of candidate network connection nodes may be ranked. In some embodiments, ranking the plurality of candidate network connection nodes comprises determining a best network connection node (e.g., highest ranking) and one or more alternative network connection nodes based on TOPSIS. TOPSIS may comprise ranking a set of alternative network connection nodes based on their similarity to an ideal solution and/or dissimilarity from an anti-ideal solution. An ideal solution may comprise the most desirable values possible for each criterion, while an anti-ideal solution may comprise the least desirable values possible for each criterion. As such, alternative network connection nodes that are closer to the ideal solution and farther from the anti-ideal solution may be ranked higher.

In some embodiments, initiating performance of a RSSI and delay-based handover comprises determining a target node for a UE based on the ranking of the plurality of candidate network connection nodes with respect to RSSI and link delay. For example, a target node for a UE may comprise a selection of the best (e.g., highest ranking) network connection node or an alternative (e.g., second highest ranking) network connection node based on RSSI values and link delay values associated with the best network connection node and the alternative network connection node. In addition to RSSI, link delay, which represents latency in a link, may be considered for selecting a best candidate network connection node as a target node for the UE. The RSSI and link delay may capture the influence of distance between a UE and a network connection node, propagation, and/or environmental conditions. In some embodiments, a larger weight may be assigned to RSSI values over link delay values if a range of RSSI values of the plurality of candidate network connection nodes is larger than a range of link delay values of the plurality of candidate network connection nodes.

According to various embodiments of the present disclosure, limiting usage of 5G cellular resources (e.g., gNBs 104) and reducing the incidence of failed handovers is achieved by initiating performance of WiFi offloading in accordance with a next best selection. That is, between network connection nodes comprising gNBs and wireless APs, gNBs may be more likely to have the strongest transmit power and highest rankings. Thus, for a given UE, the best network connection node may comprise a gNB despite the availability of wireless APs having significant enough RSSI to support the UE without affecting throughput. To reduce and/or avoid selecting a gNB, if the best network connection node is a gNB, the next best alternative (e.g., alternative network connection node) to the gNB may be selected as the target node.

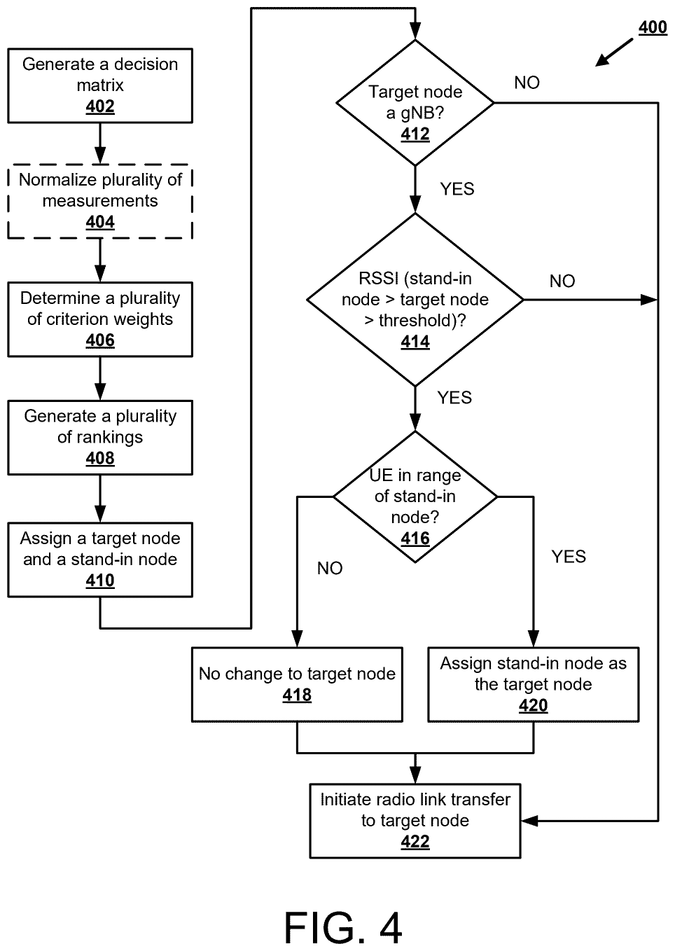

FIG. 4 is a flowchart of an example process 400 for performing a handover of a UE in accordance with some embodiments of the present disclosure. It is noted that each block of a flowchart, and combinations of blocks in the flowchart, may be implemented by various means such as hardware, firmware, circuitry, and/or other devices associated with execution of software including one or more computer program instructions. For example, one or more of the steps/operations described in FIG. 4 may be embodied by computer program instructions, which may be stored by a non-transitory memory of an apparatus employing an embodiment of the present disclosure and executed by a processor component in an apparatus (such as, but not limited to, a SDNC 200). For example, these computer program instructions may direct the processor component to function in a particular manner, such that the instructions stored in the computer-readable storage memory produce an article of manufacture, the execution of which implements the function specified in the flowchart block(s).

In some embodiments, an apparatus performs various steps/operations of the process 400 to strategically handover a UE to a wireless AP node, such as a WiFi network, other than a gNB, when the target node is a gNB to free up cellular (e.g., 5G) spectrum. Furthermore, the UE may be connected to a link with better link delay and RSSI combined thereby improving the latency of the connection to provide the UE with better quality of service.

In some embodiments, the process 400 begins at step/operation 402 when the SDNC 200 generates a decision matrix that comprises a plurality of candidate network connection nodes and a plurality of network quality measurements. The network quality measurements may comprise RSSI, link delay, bandwidth, and/or base station loads, that correspond to the plurality of candidate network connection nodes. The plurality of candidate network connection nodes may correspond to wireless APs and gNBs that are within a range of a UE. As such, the plurality of candidate network connection nodes may comprise a list of possible targets for handover of the UE.

In some embodiments, at optional step/operation 404, the SDNC 200 normalizes the plurality of network quality measurements. Normalizing the plurality of network quality measurements may comprise converting raw values from the plurality of network quality measurements into normalized values that are within a scale or range (e.g., min-max scaling or z-score normalization).

In some embodiments, at step/operation 406, the SDNC 200 determines a plurality of criterion weights corresponding to a plurality of criteria. The plurality of criterion weights may be determined by determining an entropy value for each criterion of the plurality of criteria and determining the plurality of criterion weights based on the entropy values corresponding to the plurality of criteria. As disclosed herein, an entropy value may be representative of an amount of information preserved within, or a variation in, a range of values for a criterion. The plurality of criteria may be based on network quality, such as RSSI, link delay, bandwidth, and/or load at the base stations. In some embodiments, the plurality of criteria is network, coverage, user, and/or service-based. As an example, a larger weight may be assigned to an RSSI criterion, if the range of RSSI values of a UE is larger than a corresponding range of delay values.

In some embodiments, at step/operation 408, the SDNC 200 generates, using the plurality of (optionally normalized) network quality measurements, a plurality of rankings for the plurality of candidate network connection nodes based on the plurality of criteria and the plurality of criterion weights. In some embodiments, generating the plurality of rankings comprises ranking the plurality of candidate network connection nodes by (i) determining an ideal possible candidate network connection node and an anti-ideal possible candidate network connection node and (ii) determining a distance and/or similarity measure of the plurality of candidate network connection nodes relative to the ideal possible candidate network connection node or the anti-ideal possible candidate network connection node, in a TOPSIS manner, with respect to the plurality of criteria (e.g., RSSI and/or link delay values) and the plurality of criterion weights. For example, an ideal possible candidate network connection node may comprise the most desirable weighted values possible for each criterion, while an anti-ideal possible candidate network connection node may comprise the least desirable weighted values possible for each criterion. In some embodiments, the distance and/or similarity measure may comprise a Euclidean distance. For example, a highest-ranking candidate network connection node may comprise a candidate network connection node with a shortest Euclidean distance from an ideal possible candidate network connection node and/or a longest Euclidean distance from an anti-ideal possible candidate network connection node. Conversely, a lowest-ranking candidate network connection node may comprise a candidate network connection node with a longest Euclidean from an ideal possible candidate network connection node and/or a shortest Euclidean distance from an anti-ideal possible candidate network connection node.

In some embodiments, at step/operation 410, the SDNC 200 assigns, based on the plurality of rankings for the plurality of candidate network connection nodes, a highest-ranking candidate network connection node from the plurality of candidate network connection nodes as a target node and a second-ranking candidate network connection node from the plurality of candidate network connection nodes as a stand-in node.

In some embodiments, at step/operation 412, the SDNC 200 determines if the target node is a gNB.

In some embodiments, if the target node is a gNB, at step/operation 414, the SDNC 200 determines if the RSSI value of the stand-in node is greater than the RSSI value of the target node and a predetermined threshold (e.g., −80 dB).

In some embodiments, if the RSSI value for the stand-in node is greater than the threshold, at step/operation 416, the SDNC 200 determines if the UE is within range of the stand-in node.

In some embodiments, if either the target node is not a gNB or the RSSI value is not greater than the threshold, at step/operation 422, the SDNC 200 initiates a radio link transfer or handover of the UE to the target node.

In some embodiments, if the UE is not within range of the stand-in node, at step/operation 418, the highest-ranking candidate network connection node remains assigned as the target node.

In some embodiments, at step/operation 420, if the UE is within range of the stand-in node, the stand-in node is assigned as the target node.

In some embodiments, subsequent to steps/operations 418 or 420, at step/operation 422, the SDNC 200 initiates a radio link transfer or handover of the UE to the target node, as assigned.

### Conclusion

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. A computer-implemented method comprising:
generating, by one or more processors, a decision matrix, wherein (i) the decision matrix comprises a plurality of candidate network connection nodes and a plurality of network quality measurements corresponding to the plurality of candidate network connection nodes, (ii) the plurality of network quality measurements comprises received signal strength indicator (RSSI) and link delay, and (iii) the plurality of candidate network connection nodes correspond to a plurality of wireless access points or base stations that are within a range of a user equipment (UE);
determining, by the one or more processors, a plurality of criterion weights based on a plurality of entropy values corresponding to a plurality of criteria;
generating, by the one or more processors and using the plurality of network quality measurements, a plurality of rankings for the plurality of candidate network connection nodes based on the plurality of criteria and the plurality of criterion weights;
assigning, by the one or more processors and based on the plurality of rankings for the plurality of candidate network connection nodes, a highest-ranking candidate network connection node from the plurality of candidate network connection nodes as a target node and a second-ranking candidate network connection node from the plurality of candidate network connection nodes as a stand-in node;
responsive to determining (i) the target node comprises a base station and (ii) a stand-in node RSSI value of the stand-in node is greater than (a) a target node RSSI value of the target node and (b) a threshold value, assigning, by the one or more processors, the stand-in node as the target node; and
initiating, by the one or more processors, a radio link transfer or handover of the UE to the target node.

2. The computer-implemented method of claim 1 further comprising normalizing the plurality of network quality measurements by converting a plurality of raw values from the plurality of network quality measurements into a plurality of normalized values that are within a scale or range.

3. The computer-implemented method of claim 1, wherein the plurality of criteria is based on RSSI, link delay, bandwidth, or base station load.

4. The computer-implemented method of claim 1, wherein the plurality of criteria is network, coverage, user, or service-based.

5. The computer-implemented method of claim 1, wherein generating the plurality of rankings comprises ranking the plurality of candidate network connection nodes by (i) determining an ideal possible candidate network connection node and an anti-ideal possible candidate network connection node and (ii) determining, based on the plurality of criteria and the plurality of criterion weights, a distance or similarity measure of the plurality of candidate network connection nodes relative to the ideal possible candidate network connection node or the anti-ideal possible candidate network connection node.

6. The computer-implemented method of claim 5, wherein the highest-ranking candidate network connection node comprises a shortest Euclidean distance from an ideal possible candidate network connection node or a longest Euclidean distance from the anti-ideal possible candidate network connection node.

7. A system comprising
one or more processors and
at least one memory storing processor-executable instructions that, when executed by any of the one or more processors, causes the one or more processors to perform operations comprising:
generating a decision matrix, wherein (i) the decision matrix comprises a plurality of candidate network connection nodes and a plurality of network quality measurements corresponding to the plurality of candidate network connection nodes, (ii) the plurality of network quality measurements comprises received signal strength indicator (RSSI) and link delay, and (iii) the plurality of candidate network connection nodes correspond to a plurality of wireless access points or base stations that are within a range of a user equipment (UE);
determining a plurality of criterion weights based on a plurality of entropy values corresponding to a plurality of criteria;
generating, using the plurality of network quality measurements, a plurality of rankings for the plurality of candidate network connection nodes based on the plurality of criteria and the plurality of criterion weights;
assigning, based on the plurality of rankings for the plurality of candidate network connection nodes, a highest-ranking candidate network connection node from the plurality of candidate network connection nodes as a target node and a second-ranking candidate network connection node from the plurality of candidate network connection nodes as a stand-in node;
responsive to determining (i) the target node comprises a base station and (ii) a stand-in node RSSI value of the stand-in node is greater than (a) a target node RSSI value of the target node and (b) a threshold value, assigning the stand-in node as the target node; and
initiating a radio link transfer or handover of the UE to the target node.

8. The system of claim 7, wherein the operations further comprise normalizing the plurality of network quality measurements by converting a plurality of raw values from the plurality of network quality measurements into a plurality of normalized values that are within a scale or range.

9. The system of claim 7, wherein the plurality of criteria is based on RSSI, link delay, bandwidth, or base station load.

10. The system of claim 7, wherein the plurality of criteria is network, coverage, user, or service-based.

11. The system of claim 7, wherein generating the plurality of rankings comprises ranking the plurality of candidate network connection nodes by (i) determining an ideal possible candidate network connection node and an anti-ideal possible candidate network connection node and (ii) determining, based on the plurality of criteria and the plurality of criterion weights, a distance or similarity measure of the plurality of candidate network connection nodes relative to the ideal possible candidate network connection node or the anti-ideal possible candidate network connection node.

12. The system of claim 11, wherein the highest-ranking candidate network connection node comprises a shortest Euclidean distance from an ideal possible candidate network connection node or a longest Euclidean distance from the anti-ideal possible candidate network connection node.

13. One or more non-transitory computer-readable storage media storing instructions that, when executed by one or more processors, cause the one or more processors to perform operations comprising:
generating a decision matrix, wherein (i) the decision matrix comprises a plurality of candidate network connection nodes and a plurality of network quality measurements corresponding to the plurality of candidate network connection nodes, (ii) the plurality of network quality measurements comprises received signal strength indicator (RSSI) and link delay, and (iii) the plurality of candidate network connection nodes correspond to a plurality of wireless access points or base stations that are within a range of a user equipment (UE);
determining a plurality of criterion weights based on a plurality of entropy values corresponding to a plurality of criteria;
generating, using the plurality of network quality measurements, a plurality of rankings for the plurality of candidate network connection nodes based on the plurality of criteria and the plurality of criterion weights;
assigning, based on the plurality of rankings for the plurality of candidate network connection nodes, a highest-ranking candidate network connection node from the plurality of candidate network connection nodes as a target node and a second-ranking candidate network connection node from the plurality of candidate network connection nodes as a stand-in node;
responsive to determining (i) the target node comprises a base station and (ii) a stand-in node RSSI value of the stand-in node is greater than (a) a target node RSSI value of the target node and (b) a threshold value, assigning the stand-in node as the target node; and
initiating a radio link transfer or handover of the UE to the target node.

14. The one or more non-transitory computer-readable storage media of claim 13, wherein the operations further comprise normalizing the plurality of network quality measurements by converting a plurality of raw values from the plurality of network quality measurements into a plurality of normalized values that are within a scale or range.

15. The one or more non-transitory computer-readable storage media of claim 13, wherein the plurality of criteria is based on RSSI, link delay, bandwidth, or base station load.

16. The one or more non-transitory computer-readable storage media of claim 13, wherein the plurality of criteria is network, coverage, user, or service-based.

17. The one or more non-transitory computer-readable storage media of claim 13, wherein generating the plurality of rankings comprises ranking the plurality of candidate network connection nodes by (i) determining an ideal possible candidate network connection node and an anti-ideal possible candidate network connection node and (ii) determining, based on the plurality of criteria and the plurality of criterion weights, a distance or similarity measure of the plurality of candidate network connection nodes relative to the ideal possible candidate network connection node or the anti-ideal possible candidate network connection node.

18. The one or more non-transitory computer-readable storage media of claim 17, wherein the highest-ranking candidate network connection node comprises a shortest Euclidean distance from an ideal possible candidate network connection node or a longest Euclidean distance from the anti-ideal possible candidate network connection node.
